(19) United States
(12) Patent Application Publication
(10) Pub. No.: US 2022/0089958 A1
(43) Pub. Date: Mar. 24, 2022

(54) HEAT TRANSFER SYSTEM

(71) Applicant: SOLRAY HOLDINGS LIMITED, Christchurch 8023 (NZ)

(72) Inventor: Christopher Francis BATHURST, Christchurch (NZ)

(21) Appl. No.: 17/432,883

(22) PCT Filed: Mar. 4, 2020
(86) PCT No.: PCT/IB2020/051814

§ 371 Date: Aug. 20, 2021

(30) Foreign Application Priority Data
Mar. 5, 2019 (NZ) 751299

(51) Int. Cl. C10G 3/00; F28D 11/04; F28F 1/40; F28F 5/00; C10G 1/00; C10G 1/02; B09B 3/40; B09B 3/70; C02F 11/18

(52) U.S. Cl. CPC C10G 3/40; F28D 11/04; F28F 1/40; F28F 5/00; C10G 1/002; C10G 1/02; C10G 2300/4012; B09B 3/70; C02F 11/18; C10G 2300/1003; C10G 2300/1011; C10G 2300/4006; B09B 3/40

(57) ABSTRACT

The invention disclosed generally relates to a heat exchange system comprising an outer tube, an inner tube generally located within the outer tube and comprising a longitudinal axis running along the length of the inner tube, and a fixed elongate member located within the inner tube and comprising a longitudinal axis running along the length of the elongate member. The inner tube is mounted on a rotational drive system to rotate the inner tube about its longitudinal axis. The system further includes at least one inlet and at least one outlet. One or more projecting members project from an outer surface of the elongate member, an outer surface of the inner tube or an inner surface of the outer tube.

### BACKGROUND

### Field of the Invention

The present disclosure generally relates to a shell in tube or tube in tube heat exchange system configured to enhance the heat transfer of sludge within the system.

### Description of the Related Art

The sustainability and environmental suitability of conventional fuel sources have become a concern. Because of the increasing environmental concerns associated with the combustion of hydrocarbons, and the variable cost of oil, the suitability of alternative fuels is being investigated and is gaining acceptance.

Accordingly, the use of raw organic materials such as algae, waste carbonaceous materials, cellulosic and lignocellulosic biomasses, for example, are increasingly considered promising alternative fuel sources to produce a crude oil/biofuel.

Typically, the raw organic material is made into a thick, pumpable sludge and is the treated in a processing system at near supercritical temperatures and pressures to produce crude oil. In processing systems disclosed, for example, in PCT/NZ2008/000309; PCT/NZ2011/000065; PCT/NZ2011/000066; and PCT/NZ2011/000067, the organic material is fed into a processing system as a raw product feedstock in the form of a sludge, which may be abrasive and/or corrosive, particularly at the high temperatures and pressures used in the processing system. In some systems, the feedstock enters a pumping system (driver) that pressurises the feedstock in two stages, with a set point of up to about 350 bar, before the pressurised feedstock is pushed into the next available one of a number of reactors. Here, the feedstock is heated under pressure to convert the feedstock to a raw product comprising crude oil/biofuel, which is then cooled and depressurised. In one form of reactor, the feedstock enters an inner tube of the reactor and is heated while moving along the reactor in stages until reaching the end of the inner tube and entering an outer tube of the reactor. At this stage, the sludge passing through the outer tube may reach a set point temperature of up to 400° C. to convert the feedstock into raw product in the form of crude oil. The hot crude oil raw product stream is then pushed back along an annular space between the outer reactor tube and the inner reactor tube by successive stages of incoming feedstock. While moving back along this annular space, the hot crude oil is cooled by heat transfer through the wall of the inner reactor tube from the cooler incoming raw product stream located within the inner reactor tube. Similarly, the hot crude oil in the outer reactor tube helps to heat the incoming raw product stream in the inner reactor tube by heat transfer through the wall of the inner reactor tube. Eventually, the cooled crude oil will reach the end of the annular space and leaves the reactor tube to be directed back to the driver pumping system. The pumping system then depressurises the cooled crude oil in stages. Some processing systems are set up to efficiently heat, convert, and cool the organic material by using a plurality of reactors in parallel. In some of these processing systems, the pumping system feeds each reactor in turn by pressurising and pushing feedstock into the respective reactor. At the same stage, the pumping system receives pressurised, cooled crude oil raw product from the reactor. In effect, at least a portion of the reactor tubes comprises a shell and tube heat exchanger, leading to a hot end/reaction zone where the reaction occurs and a cooled delivery end where the feedstock enters and the crude oil raw product leaves, typically as a sludge. External heaters may also be used and may surround the hot end of the reactor to provide the final heating effort to reach the set point temperature necessary for the conversion.

Being able to provide an efficient heat transfer rate between the feed sludge and the products of the process is important because the feed sludge must be raised to the reaction temperature, then after the reaction, subsequently cooled back to ambient levels before being discharged. The reaction process at reaction temperature is very rapid and in fact most of the process time is taken up with the heating and cooling steps of the process. To maximise the efficiency of the heat transfer rate, much of the heating and cooling steps is carried out regeneratively with heat being transferred from the raw product to the incoming feedstock. The heat transfer generally takes place through the wall of the feed tube/inner tube which is immersed in the raw product stream located in the outer tube. At the reaction zone, which is located at the innermost end of the inner and outer tubes, heaters may be provided outside of the outer tube to increase the temperature of material within the reaction zone to the optimum level, Because both the feedstock being heated and the raw product being cooled are in the form of a thick, heavy sludge, inefficiencies have been found in the heat transfer rate between the feedstock sludge and the crude oil raw product sludge because the heavy sludges inhibit natural convention currents that otherwise allow for efficient heat transfer rates.

It is therefore an object of the present invention to provide a heat exchange system that improves the heat transfer rate of a sludge feedstock and sludge crude oil raw product passing through the system, or that at least provides a useful alternative to known heat exchange systems.

In this specification where reference has been made to patent specifications, other external documents, or other sources of information, this is generally to provide a context for discussing features of the invention. Unless specifically stated otherwise, reference to such external documents or sources of information is not to be construed as an admission that such documents or such sources of information, in any jurisdiction, are prior art or form part of the common general knowledge in the art.

### SUMMARY OF THE INVENTION

In a first aspect, the present disclosure relates to a heat exchange system comprising an outer tube and an inner tube generally located within the outer tube. The inner tube comprises a longitudinal axis running along the length of the inner tube. The heat exchange system also comprises a fixed elongate member located within the inner tube and comprising a longitudinal axis running along the length of the elongate member. The inner tube is mounted on a rotational drive system comprising a drive motor to rotate the inner tube about its longitudinal axis. The system further includes at least one inlet and at least one outlet, each being located in the outer tube or the at least one inner tube. One or more projecting members project from an outer surface of the elongate member, an outer surface of the inner tube or an inner surface of the outer tube.

In one form, the inner tube comprises the at least one inlet. Preferably, the outer tube comprises the at least one outlet.

In some forms, the elongate member is a metal shaft. The elongate member may comprise an outer surface on which is located at least one projecting element. The at least one projecting element may optionally be in the form of a thread that extends along at least a portion of the outer surface of the elongate member to provide the elongate member with an at least partially threaded outer surface.

In one form, the outer surface of the elongate member comprises a plurality of projections along at least a portion of its length. The elongate member is preferably located generally centrally within the inner tube so that the longitudinal axes of the inner tube and elongate member generally align.

In one form, the projections are shaped as paddles.

In one form, the inner tube comprises an inner surface and an outer surface and the outer surface comprises at least one projecting element.

Optionally, at least one projecting element is in the form of a thread that extends along at least a portion of the outer surface of the inner tube to provide the inner tube with an at least partially threaded outer surface.

In one form, the outer surface of the inner tube comprises a plurality of projecting elements along at least a portion of its length.

Optionally the projecting elements are shaped as paddles.

In a second aspect, present disclosure relates to a system for converting a raw feedstock sludge comprising organic material into crude oil, the system comprising; a pressurizing section comprising an inlet and at least one pump to pressurise the feedstock; a processing section comprising a reactor according to any one of the preceding claims, the reactor being configured to heat the feedstock, convert the feedstock to a crude oil within a reaction zone of the reactor, and cool the crude oil before discharging the crude oil from the reactor; and an output section configured to receive the discharged crude oil from the reactor and comprising a depressurising chamber that depressurises the crude oil before the crude oil is discharged from the system via an outlet.

Preferably, the system further comprises a fluid flow path between the inlet and the outlet and a pressure equalisation system to equalise pressures between two valves along the fluid flow path before opening one of the two valves.

This invention may also be said broadly to consist in the parts, elements and features referred to or indicated in the specification of the application, individually or collectively, and any or all combinations of any two or more said parts, elements or features. Where specific integers are mentioned herein which have known equivalents in the art to which this invention relates, such known equivalents are deemed to be incorporated herein as if individually described.

The term ‘comprising’ as used in this specification and claims means ‘consisting at least in part of’. When interpreting statements in this specification and claims that include the term ‘comprising’, other features besides those prefaced by this term can also be present. Related terms such as ‘comprise’ and ‘comprised’ are to be interpreted in a similar manner.

It is intended that reference to a range of numbers disclosed herein (for example, 1 to 10) also incorporates reference to all rational numbers within that range and any range of rational numbers within that range (for example, 1 to 6, 1.5 to 5.5 and 3.1 to 10). Therefore, all sub-ranges of all ranges expressly disclosed herein are hereby expressly disclosed.

As used herein the term ‘(s)’ following a noun means the plural and/or singular form of that noun. As used herein the term ‘and/or’ means ‘and’ or ‘or’, or where the context allows, both.

### BRIEF DESCRIPTION OF THE DRAWINGS

Embodiments will now be described by way of example only and with reference to the accompanying drawings in which:

FIG. 1 is a schematic illustration of one form of processing system for converting organic material into crude oil that may use a heat exchange system according to the invention;

FIG. 2 is an illustrative cross-sectional side view of one form of a shell and tube heat exchange system according to the invention;

FIG. 3 is an illustrative cross-sectional side view of one form of inner tube that may be placed within an outer tube of a heat exchange system according to the invention, the inner tube being mounted onto a tube support at one end;

FIG. 4 is an illustrative cross-sectional side view of one form of elongate member/stirring arm comprising multiple projections, in the form of fins, that may be placed within an inner tube of a shell and tube heat exchange system according to the invention; and

FIG. 5 shows an illustrative cross-sectional view showing one form of reactor comprising an outer tube/shell, a rotating inner tube mounted on a tube support, and a stationary elongate member/stirring arm, in which the elongate member and inner tube are concentrically arranged within the outer tube;

FIG. 6a shows an illustrative cross-sectional side view of another form of inner tube mounted on a tube support and comprising a plurality of fins located equidistant along the length of the inner tube;

FIG. 6b shows an illustrative cross-sectional top view of the inner tube of FIG. 6a, engaged with a rotational drive system; and

FIG. 7 shows an illustrative side view of yet another form of inner tube comprising a single projecting member that spirals around the tube to form a thread.

### DETAILED DESCRIPTION

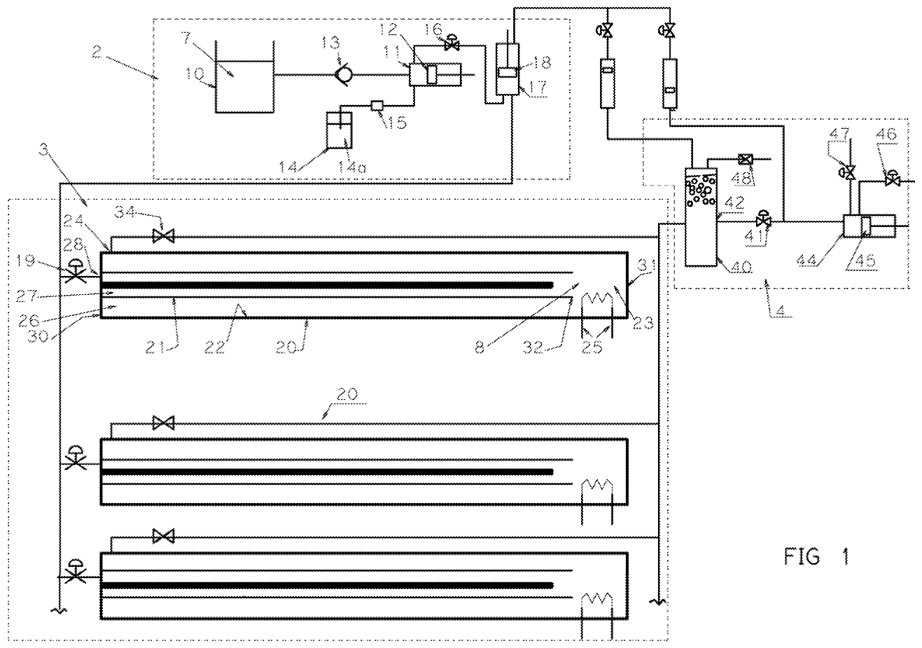

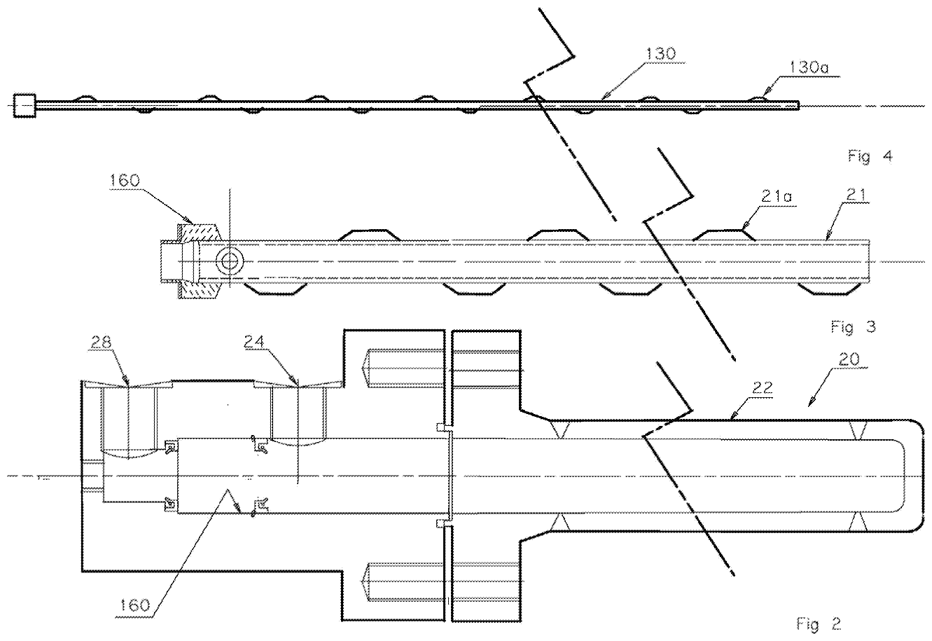

Various embodiments and methods of manufacture will now be described with reference to FIGS. 1 to 7. In these Figures, like reference numbers are used in different embodiments to indicate like features. Directional terminology such as the terms ‘front’, ‘rear’, ‘upper’, ‘lower’, and other related terms are used in the following description for ease of description and reference only, it is not intended to be limiting.

In general, the invention relates to a processing system comprising a heat exchanger having at least one rotating element along at least a portion of the fluid flow path through the heat exchanger and comprising one or more projecting members configured to stir/mix/fold heavy sludge material passing along the fluid flow path to assist heat transfer within the heat exchanger. The invention also relates to a heat exchanger for use in the processing system.

FIG. 1 illustrates one form of processing system 1 for processing solid-liquid slurries/sludges into alternative petrochemicals, which may otherwise be referred to as crude oil, hydrocarbons or biofuel. System 1 includes a pressurizing section 2, a processing section 3 and an output section 4. The pressurizing section 2 receives, via an inlet, the solid-liquid slurry feedstock 7 to be processed and pressurizes the feedstock 7; the processing section 3 heats and processes the pressurized feedstock 7, then cools a resultant raw product stream; and the output section 4 depressurizes and outputs the product stream through an outlet.

The feedstock 7 can be made up of various organic materials to be converted to useful hydrocarbon fuels, for example dry cleaning sludge, biosolids sludge, de-lignitised sludge and/or algae for production of hydrocarbons. The sludge is a mixture that is prepared by mixing the organic material with water or a water containing material to prepare a pumpable sludge. Generally, the feedstock 7 can be any bio/organic material which can be processed in a system with high pressures for conversion to crude oil/hydrocarbons/biofuel. Such feedstock can also contain abrasive and/or “dirty” particulate matter, which is abrasive and/or corrosive to valves and component parts of the system. Also, if certain flow velocities are reached and in the absence of controls to avoid such velocities, then valves and component parts of the system 1 can be damaged. The solid-liquid slurry feedstock 7 can also be referred to as sludge, fluid, biomass, or other terms indicative of the organic material to be converted to alternative petrochemical feedstock, such as crude oil/hydrocarbons/biofuel.

In the treatment process shown in FIG. 1, the feedstock enters the pressurizing section 2 via an inlet and is pressurized before being processed by the processing section 3. The pressurizing section 2 typically includes a feed tank 10 connected to a first pump 11 via a conduit on which is located a non-return valve 13.

In one form, the first pump 11 includes a first piston 12 that moves up and down within a cylinder and that is driven by any suitable means. However, if alternative forms of pump are used, the piston may be replaced with other suitable pumping means as would be apparent to a person skilled in the art.

The first pump 11 is configured to draw feedstock 7 from the feed tank 10 and provide an initial low pressurization. For example, the feedstock 7 can be drawn from the feed tank 10 by moving the piston 12 to create a vacuum. This causes the feedstock 7 to move from the feed tank 10 to the first pump 11 via the conduit and non-return valve 13. The non-return valve 13 prevents the feedstock 7 from moving back toward the feed tank 10.

The pressurizing section 2 also optionally contains an additive tank 14, configured to contain an additive 14a. The additive tank is connected with an additive pump 15 that pumps one or more additives to the first pump 11 via a conduit that connects the additive tank 14 to the first pump 11. This creates a feedstock 7 and additive 14a mixture in the first pump 11.

A first valve/mixing valve 16 may be positioned on a conduit connected with the first pump 11 and with a pressurizing element, such as a second pump 17. The first valve 16 can be closed to allow the first pump 11 to mix the feedstock 7 with the additive 14a within the pump 11, and the valve can be opened to allow the feedstock/mixture to be pumped from the first pump 11 to the second pump 17 via the conduit.

The feedstock 7 discharged from the feed tank 10 may form an abrasive or corrosive flow stream that is pumped through the various conduits or lines, valves reactors, and/or separation units in the processing system 1.

The second pump 17 may be a high pressure pump that includes a pump housing in the form of a cylinder within which a second piston 18 is located. The second piston 18 is optionally a floating piston. The second piston 18 is configured to slide back and forth along the cylindrical pump housing in the usual manner. If alternative forms of pump are used, the piston may be replaced with other pumping means as would be apparent to a person skilled in the art.

The second pump 17 is configured to pressurize the raw feedstock sludge 7 exiting the first pump 11 and valve 16. The second pump 17 may also be connected with at least one second valve/pressurizing valve 19 located between the second pump and one or more reactors of the processing section 3. In one form, the system may comprise a single reactor. In other forms, the system may comprise multiple reactors arranged in parallel. Where multiple reactors are used, the system will comprise a section valve 19 for each reactor. Each second valve 19 will be located upstream of the respective reactor.

For the sake of simplicity, a system comprising a single reactor will be described, but it should be appreciated that a system comprising multiple reactors would operate in the same way.

After the feedstock 7 is pumped into the second pump 17 by the first pump 11, the first and second valves 16 and 19 are closed and the raw feedstock sludge is pressurised.

The second valve(s) 19 can then be opened to allow the pressurized raw feedstock sludge 7 to be moved from the second pump 17 to the processing section 3.

The first and second valves 16, 19; and first and second pumps 11, 17 all form part of the pressurizing section 2.

Optionally, the system can be adapted to allow the feedstock 7 to be moderately preheated in the pressurizing section 2 by including heaters (not shown) along a section of the conduit, or in other suitable locations.

The processing section 3 is configured to heat the pressurized raw feedstock sludge 7 to supercritical or near supercritical temperatures. Typically, the feedstock 7 will be heated to a temperature between 250° C. and 400° C. However, it is envisaged that the system and process may also be used to process feedstock 7 at temperatures outside this range.

The feedstock 7 can be pressurized in the pressurizing section 2 only, as described above. Alternatively, the raw feedstock sludge 7 can instead be pressurized in the processing section 3 only. In yet another form, the feedstock 7 may be initially pressurised in the pressurizing section 2 and may be pressurised further in the processing section 3.

The processing section may comprise at least one processing vessel/reactor 20 or multiple reactors in parallel, as shown in FIG. 1. Each reactor 20 comprises a first stage 27 and a second stage 26. The reactor also comprises a first end 30 and a second end 31 that substantially opposes the first end 30. The reactor comprises an inlet 28 for receiving raw feedstock sludge 7. In one form, the inlet is positioned at or near the first end 30 of the reactor and is connected to the outlet of the second valve 19. The reactor also comprises an outlet 24 for discharging the raw product/crude oil. In a preferred form, the outlet 24 is also positioned at or near the first end 30 of the reactor. However, in other forms, the outlet may be positioned at any other suitable location on the reactor.

The first stage 27 of the reactor may comprise a first tube/inner tube 21 comprising a first end and a second end 32. The first end of the inner tube 21 is located at the first end of the reactor 20. The inner tube is in fluid connection with the reactor inlet 28. In a preferred form, the reactor inlet comprises an opening formed in the inner tube 21 at or near the first end of the inner tube. The inner/first tube 21 is positioned concentrically within a second tube/outer tube 22 that forms the casing of the reactor 20. The outer tube 22 has a first end located at the first end of the reactor 20 and a second end located at the second end of the reactor. The outer tube is in fluid connection with the reactor outlet 24. In a preferred form, the reactor outlet 24 comprises an opening formed in the outer tube 22 at or near the first end of the outer tube. Typically, the outlet is formed at or near the first end of the outer tube 22. A space (preferably an annular space) is provided between the outer peripheral surfaces of the first tube 21 and the inner surfaces of the second tube 22. This space defines the second stage 26 within the reactor 20 and leads to the outlet 24.

The first/inner tube 21 is shorter than the outer tube 22, so that the second end 32 of the inner tube terminates before the second end 31 of the reactor 20. A space is provided between the second end 32 of the first tube 21 and the second end 31 of reactor 20. This space forms a reaction zone/reaction chamber 23 where pressurized, high temperature feedstock 7 reacts to form a raw product stream 8. The inlet 28, inner tube 21, reaction zone 23, outer tube 22, and outlet 24 form a fluid pathway along which the raw feedstock sludge 7 passes through the reactor 20. The inner and outer surfaces of both the first and second tubes 21, 22 are heat transfer surfaces.

Each end 30, 31 of the reactor 20 is sealed, except where the inlet 28 enters the reactor 20 and where the outlet 24 exits the reactor. This arrangement allows the reactor 20 to be used as a pressure vessel in which the same pressure is maintained within the reactor.

In use, feedstock 7 enters the inner tube 21 via the inlet 28. The raw feedstock sludge 7 moves through the fluid flow path defined by the inner tube 21 and is heated before reaching the reaction zone 23, where the feedstock 7 is preferably further heated to a desired temperature by a heating system 25 that causes the feedstock 7 to react to form a raw product stream. The raw product stream may be an abrasive and/or corrosive flow stream containing raw product from the reactor 20.

The heating system 25 is configured to heat the pressurized feedstock 7 in the reaction chamber 23 up to between 250° C. and 400° C. The heating system 25 may comprise one or more heaters, such as elements or other suitable heating equipment. The heating system 25 can be inserted directly into the reaction zone 23 to heat the feedstock 7 or it can be adapted to be located externally from the reaction zone 23 so as to heat the walls of the reactor 20 at or near the location of the reaction zone 23.

The heating system 25 may be configured to heat the pressurized raw feedstock sludge 7 in the reaction chamber 23 by radiation, convection, conduction, electromagnetic radiation, including microwave and ultrasonic radiation, or any combination of such heating methods or by similar heating methods.

The raw product 8 (which may include unreacted feedstock 7) then moves along the flow stream between the inner tube wall and the outer tube wall, as defined by the second stage 26, where the raw product stream 8 is cooled to an ambient or near ambient temperature, for example at or below 80° C., before being discharged from the processing section 3 via the outlet 24.

In effect, the inner and outer tubes 21, 22 form a counter-flow heat exchanger. Optionally, the first tube 21 is made of a highly heat conductive material, such as a thin walled metal tube, to ensure a high heat transfer co-efficient. In addition, fins or other stirring elements that encourage stirring/mixing/folding of the sludge to improve heat transfer may be incorporated onto or into the heat transfer surfaces of the reactor 20. For example, one or more stirring elements may project from the outer surface of the inner tube and/or the inner surface of the outer tube, and/or the outer surface of a centrally located axial member/stirring arm located within the inner tube, as will be discussed in further detail later in this specification.

The outlet 24 is located on the periphery of the reactor 20 and is preferably located close to the inlet 28. However, it is envisaged that the outlet 24 could be located at other suitable locations on the processing vessel 20 depending on the internal arrangement of the vessel.

In one form, the volume of the reactor 20 is at least six times that of the swept volume of the second pump 17. This volume difference enables the material to be processed to be moved through the processing vessel in intermittent stages as the pump 17 is actuated. That is, one cycle of the pump 17 would cause a single charge of material to move one sixth of the way through the reactor 20, thereby allowing for a longer residence time of the feedstock 7 within the reactor 20 than if the same charge of flow stream was pushed into the reactor with the actuation of the pump 17 and was drawn out of the reactor 20 with the next consecutive action of the pump. By allowing for a longer residence time, the feedstock 7 is able to be heated to the desired temperature more readily and is given sufficient time to undergo the desired conversion reaction within the reactor.

The reactor may also be configured to provide for more efficient heat transfer between the first stage 27 and the second stage 26. FIGS. 1 to 7 show one form of reactor 20 that may be used with a system 1 for processing an organic material into alternative petrochemical product/crude oil. The reactor comprises an outer tube/shell 22 and an inner tube 21 located concentrically within the outer tube 22. Preferably, the inner tube 21 and outer tube 22 are both cylindrical and the inner tube 21 is located coaxially and concentrically within the outer tube 22, so that the external curved wall of the inner tube 21 is equidistant from the internal curved wall of the outer tube 22. The reactor 20 also comprises an inlet 28 leading to the inner tube 21 and an outlet 24 leading from the outer tube 22.

In one form, at least one of the inner tube 21 and the outer tube 22 are concentrically located about a longitudinal axis passing through the centre of the inner and outer tubes 21, 22. Where both tubes 21, 22 rotate, the tubes may rotate in opposing directions. Preferably, the inner tube 21 is configured to rotate about its longitudinal axis and the outer tube 22 remains stationary.

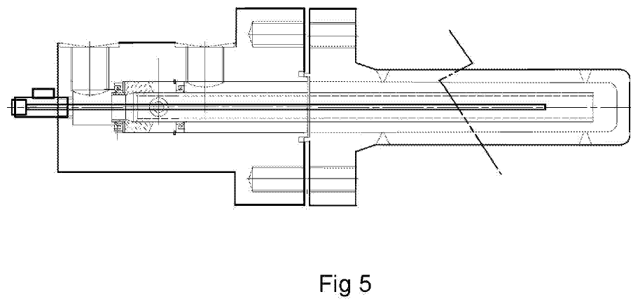

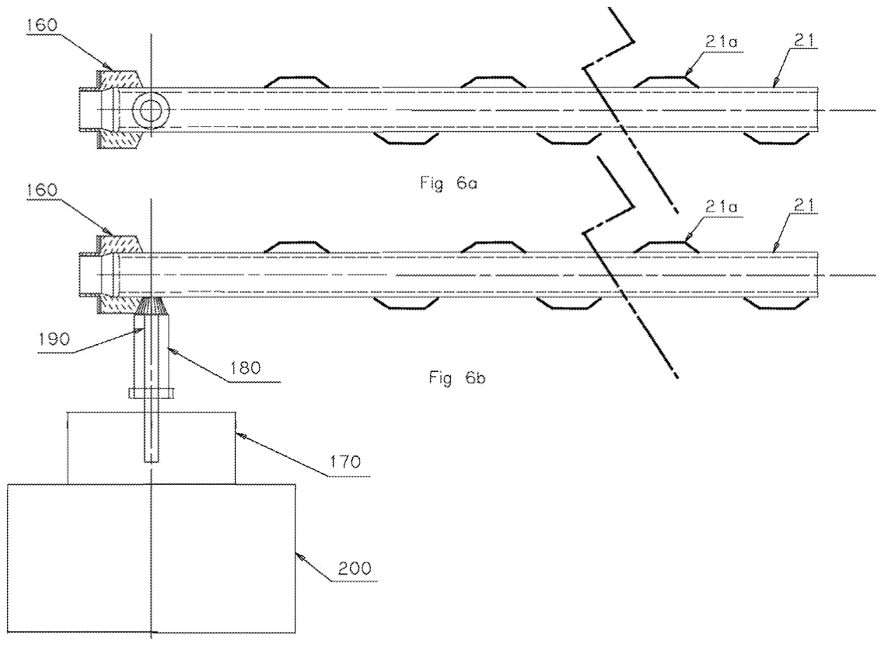

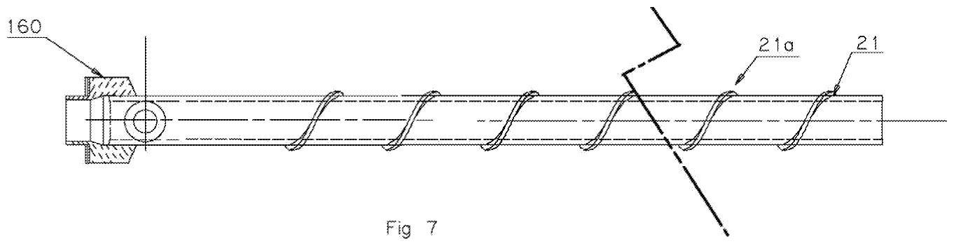

In one form, as shown in FIGS. 5 to 6b, the inner tube 21 is configured to rotate about its longitudinal axis and comprises an elongate body comprising first and second ends. The inner tube is mounted on an inner tube support 160. The inner tube support 160 comprises a body comprising a stationary portion and a rotating portion connected to a rotational drive system. In one form, the rotating portion of the inner tube support 160 comprises a crown wheel that is operatively attached to the first and/or second ends of the inner tube 21 and is also operatively configured to engage with the rotational drive system. The rotational drive system is powered by a drive motor 170, which is controlled by an electronic controller 200, as shown in FIG. 6b. In one form, the rotational drive system engages with the drive motor via a pinion shaft 180 that is located at right angles to the tube support 160. Preferably, the rotational drive system also comprises a pinion gear 190 engaged with the motor, pinion shaft and the electronic controller 200 to control the rotational speed of the inner tube 21. When driven by the motor 170, the rotating portion or crown wheel of the inner tube support 160 is caused to rotate, which causes the inner tube 21 to rotate within the outer tube 22. Preferably, the rotational drive system is configured to rotate the inner tube 21 at slow speeds, such as below about 60-70 rpm.

In one form, the curved outer surface of the inner tube 21 comprises one or more inner tube projections 21a to help stir or fold the raw product sludge 8 passing through the second stage 26, i.e. through the outer tube 22, as the inner tube rotates. By stirring/folding the sludge, it is possible to improve the efficiency of heat transfer between the inner and outer tubes 21, 22. In one form, the inner tube 21 comprises multiple projections 21a. The projections 21a may take any suitable shape and size. For example, the projections 21a may be formed as two-dimensional shapes, such as fins, vanes, or three-dimensional shapes, such as lugs. FIG. 3 shows one form of inner tube 21 that comprises multiple projections 21a in the form of fins that project from the outer surface of the inner tube 21. The projections 21a may be equidistantly spaced along the length of the tube 21 and/or around the circumference of the tube 21. Optionally, the projections may comprise distal ends that are sized and shaped to scrape the inner surface of the outer tube 22 or to at least be located proximate to the inner surface of the outer tube 22. In one form, a first series of aligned projections, such as fins, may be spaced along the length of the tube to form a first line of projections/fins and a second series of aligned projections, such as fins, may be spaced along the length of the tube 21 on the opposite side of the tube 21 to form a second line of projections or fins. In yet another form, the inner tube 21 may comprise a single projection. In one form, the single projection may comprise a thread that extends along at least a part of, or all of, the length of the outer surface of the inner tube 21, as shown in FIG. 7. The threaded outer surface of the inner tube 21 not only helps stir the raw product sludge 8 passing through the second stage 26 in the outer tube 22 but may also be configured to encourage movement of the sludge along the outer tube 22 by being threaded in the direction of flow. In an alternative arrangement, the outer surface of the inner tube 21 may be threaded in a direction opposite to the material flow within the outer tube 22 to hinder the flow of raw product sludge 8 through the second stage 26 and therefore increase the residency of raw product sludge within the outer tube 22.

Additionally or alternatively, the reactor comprises at least one elongate member/stirring arm 130 located within the inner tube 21 and extending along at least a portion of the length of the inner tube, as shown in FIG. 5. Preferably, the elongate member 130 extends along the full length of the inner tube 21 or at least from the first end of the tube to the reaction zone. The stirring arm may be located at the centre of the inner tube 21 to lie along the longitudinal axis of rotation of the inner tube 21, or the stirring arm 130 may be offset from the axis of rotation. In one form, the inner tube 21 comprises two or more stirring arms, at least one of which is offset from the axis of rotation of the inner tube 21. In a particularly preferred form, the elongate member/stirring arm 130 comprises a shaft that extends along at least a portion of the length of the inner tube 21 and is located concentrically within the tube 21 to lie along the rotational axis of the inner tube 21. The stirring arm/shaft 130 may comprise an outer surface comprising one or more stirring arm projections 130a that project from the outer surface of the elongate member 130, as shown in FIG. 4. The projections 130a may take any suitable shape and size. For example, the projections 130a may be formed as two-dimensional shapes, such as fins, vanes, or three-dimensional shapes, such as lugs. The projections/fins may be equidistantly spaced along the length of the elongate member/shaft 130 and/or around the circumference/periphery of the shaft 130a. Optionally, the projections may comprise distal ends that are sized and shaped to scrape the inner surface of the inner tube 21 or to at least be located proximate to the inner surface of the inner tube 21. In one form, a first series of aligned projections, such as fins, may be spaced along the length of the elongate member 130 to form a first line of projections/fins and a second series of aligned projections, such as fins, may be spaced along the length of the elongate member 130 on the opposite side of the elongate member to form a second line of projections/fins. In yet another form, the elongate member 130 may comprise a single projection. In one form, the single projection may comprise a thread that extends along at least a part of, or all of, the length of the outer surface of the elongate member 130. The threaded outer surface not only helps stir the raw feedstock sludge 7 passing through the inner tube 21 but may also be configured to encourage movement of the sludge 7 along the inner tube 21 by being threaded in the direction of flow. In an alternative arrangement, the outer surface of the elongate member 130 may be threaded in a direction opposite to the material flow within the inner tube 21 to hinder the flow of raw feedstock 7 through the inner tube 21 and therefore increase the residency of feedstock within the inner tube 21. In one form, the elongate member/stirring arm may comprise a solid rod formed into a long spiral, similar to a spring shape.

In another form, the stirring arm 130 may be configured to rotate. Optionally, the stirring arm may be configured to rotate in a direction opposite to the direction of rotation of the inner tube. For example, the stirring arm may be engaged with a second motor and second electronic control system to that of the inner tube to control the speed and direction of the stirring arm. Alternatively, the stirring arm may be engaged with the same motor and control system as the inner tube, but may be connected to a drive system configured to rotate the stirring arm in a direction opposite to that of the inner tube. In another form, the stirring arm is configured to rotate while the inner tube remains stationary.

In yet another form, the outer tube 22 may be configured to rotate about the inner tube 21. For example, the outer tube may be configured to rotate in a direction opposite to the direction of rotation of the inner tube. For example, the outer tube may be engaged with the second motor and second electronic control system of the missing arm to control the speed and direction of both the stirring arm and the outer tube. In another form, the outer tube may be engaged with a third motor and third electronic control system to control the speed and direction of the outer tube. Alternatively, the outer tube may be engaged with the same motor and control system as the inner tube, but may be connected to a drive system configured to rotate the outer tube in a direction opposite to that of the inner tube. Alternatively, the outer tube may be configured to rotate and the inner tube may remain stationary. In one form, both the outer tube and the stirring arm rotate in a first direction and the inner tube remains stationary or rotates in an opposite, second direction to the stirring arm and outer tube.

In one form, an inner surface of the outer tube 22 comprises one or more projections, such as fins, vanes, or three-dimensional shapes, such as lugs. For example, the inner surface of the outer tube 22 may comprise multiple fins that scrape the outer surface of the inner tube 21 or that are at least located proximate to the outer surface of the inner tube. Optionally, the fins are arranged in a line extending along the length of the outer tube or the fins are arranged to spiral along the length of the outer tube. In one form, the inner surface of the outer tube comprises a single projection that forms a thread along the inner surface of the outer tube and extends generally along the length of the outer tube.

As mentioned above, the first and second tubes 21, 22 of the reactor 20 are preferably concentric, with the first tube 21 being positioned inside the second tube 22 and defining an annular space between. However, it is envisaged that the first and second tubes 21, 22 of the reactor 20 can be of different shapes and arrangements, as would be apparent to a person skilled in the art.

Referring now to the output section 4 of the system 1, the outlet 24 of each reactor 20 connects the respective reactor 20 to the output section 4 via a conduit. The discharged raw product, which can also be abrasive or corrosive, moves along this conduit to the output section 4. Optionally, the conduit comprises one or more valves that are typically open during operation, but which may be closed when the particular reactor is disconnected for maintenance. In this arrangement, where the system comprises multiple reactors, it is possible to close the fluid flow path through a selected reactor to isolate the reactor from the system for cleaning or maintenance, and to allow the system to continue to be used to process raw material passing through the other, operating, reactors.

The output section 4 optionally includes a high pressure gas separator 40 for separating out gases from the raw product stream. In the embodiment in which a gas separator is used, the outlet 24 of the reactor 20 is connected with the inlet of the high pressure gas separator 40, which may be of a known type, so that raw product 8 moves from the reactor 20 to the gas separator 40 via a conduit. Any gases entrained, or formed in the reactor 20, and which remain within the raw product 8, are able to exit the system by being purged from the gas separator 40 through a purge valve 48 connected with the gas separator 40.

The output section may also include a third valve 41 that is connected with the outlet 24 of the reactor 20 or with an outlet 42 of the gas separator, if the gas separator 40 is included within the system 1. The third valve 41 is also in fluid communication with a pressure release chamber. In one form, the pressure release chamber forms part of a third pump 44.

The third pump 44 is typically a high pressure pump that acts as both a depressurizing chamber and as a discharge pump. In one form, the third pump 44 includes a pump housing that forms the depressurising chamber. The pump housing comprises an inlet end through which raw product sludge can enter the pump housing, and a non-inlet end. Preferably, the pump housing is in the form of a cylinder within which a third piston 45 is located. As the raw product stream enters the pump housing via the open third valve 41, the piston moves toward the other end of the housing to allow the raw product stream into the third pump 44.

The third valve 41 is controlled to open at the same time as the first valve 16 in the pressurizing section 2. This allows a charge of raw product 8 to leave the processing section 3 at the same time as a charge of raw feedstock 7 enters the processing section 3, via the first valve 16, without significantly changing the pressure level in the processing section 3. The release valve 41 acts to automatically maintain the pressure within the third pump 44 at about the same pressure as in the processing section 3, and as created by the pump action of the second pump 17 as the second pump transfers the charge of feedstock 7 into the processing section 3. When the transfer of the new charge of feedstock 7 is complete and the transfer of the latest charge of raw product 8 is complete, both the second valve 19 and third valve 41 are closed. The third piston 45 continues to move toward the non-inlet end of the pump housing, which causes the capacity of the feedstock receiving portion of the pump housing/depressurizing chamber to increase, thereby depressurizing the feedstock 7. Preferably, the raw product stream 8 is depressurized to ambient or near ambient levels.

Any gases that were dissolved in the raw product stream and that were not purged in the gas separation stage can then be ejected via a fourth valve 47, which is connected with the third pump 44 and which can also act to depressurize the raw product stream.

The third pump 44 is preferably also connected with a fifth valve in the form of an outlet valve 46. This allows the depressurized raw product stream 8 to be pumped, by actuation of the third pump 44, out through the outlet valve 46, which is opened to allow the raw product stream to be discharged from the system 1.

Because the raw product stream is at an ambient or near ambient pressure, the outlet valve 46 is subject to less wear and is, therefore, more reliable than if the raw product stream was discharged through the outlet valve under high pressure.

The fourth valve 47 helps to reduce the pressure of the raw product stream in the third pump 44 after the third valve 41 has closed but before the outlet valve 46 has opened, so that rapid wear is avoided when the outlet valve 46 is opened.

In preferred forms, a pressure equalising system is employed to balance the pressures between the second pump 17 and the gas separator 40, and also between the second pump 17 and the third pump 44 to equalise pressures before opening operating valves 16 and 41, This helps ensure that these valves are not damaged by sludge movements during the opening operations. Preferably, the pressure equalizing system is configured to equalise pressures between two valves along the fluid flow path before opening one of the two valves to allow material to pass therethrough,

The above describes one embodiment of a generalized process for conversion of solid-liquid slurry feedstock 7 to alternative petrochemical product that may be used with the reactor of the invention. However, other processes may instead be used with the reactor of the invention without departing from the scope of the invention. For example, the reactor of the invention may be used with any of the processes described within PCT/NZ2008/000309; PCT/NZ2011/000065; PCT/NZ2011/000066; and PCT/NZ2011/000067.

The above system and process has been found to be particularly advantageous at improving the rate of heat transfer between the raw feedstock 7 and the raw product stream 8. By stirring/folding the sludge in the inner tube and/or in the reaction zone and/or the outer tube, heat gains and heat losses in the heat exchange system are readily dispersed through the heavy sludge. For example, by independently causing the inner tube 21 to rotate inside the raw product 8 within the outer tube 22, and by providing one or more projecting members on the inner tube, outer tube and/or the stirring arm, a shearing and stirring effect is created in the feedstock sludge 7 and the raw product sludge 8, thereby further increasing the heat transfer. The stirring/folding effect occurs constantly as the rotating inner tube and/or stirring arm and/or outer tube rotates, even though discrete charges of raw material are pumped into the inner tube consecutively and discrete charges of raw product are output from the processing section consecutively to form a continuous processing system. This shearing/stirring/folding effect is further enhanced in embodiments in which at least one stationary stirring arm /shaft is located within the rotating inner tube 21. To further improve the rate of heat transfer, the invention allows for the outer surfaces of one or both the rotating inner tube and the stationary shaft(s) to have one or more projections to increase the shearing and stirring actions of the feedstock sludge and raw product sludge.

To provide sufficient strength and resilience, the projecting members may be made from any suitable material, but are preferably made from stainless steel.

It is anticipated from conventional chemical engineering design practice that the rate of heat transfer will be improved considerably and is expected to be more than doubled. As the production rate of raw product produced by the reactor is almost fully dependent on the time taken to heat the feedstock and to cool the raw product, it is expected the reactor production rate will be doubled by using the reactor of the invention.

Preferred embodiments of the invention have been described by way of example only and modifications may be made thereto without departing from the scope of the invention.

1. A heat exchange system comprising:
an outer tube,
an inner tube generally located within the outer tube and comprising a longitudinal axis running along the length of the inner tube,
a fixed elongate member located within the inner tube and comprising a longitudinal axis running along the length of the elongate member;
wherein the inner tube is mounted on a rotational drive system to rotate the inner tube about its longitudinal axis;
wherein the system further includes at least one inlet and at least one outlet; and
wherein one or more projecting members project from an outer surface of the elongate member, an outer surface of the inner tube or an inner surface of the outer tube.

2. The heat exchange system of claim 1, wherein the inner tube comprises the at least one inlet.

3. The heat exchange system of claim 1, wherein the outer tube comprises the at least one outlet.

4. The heat exchange system of claims 1, wherein the elongate member is a metal shaft.

5. The heat exchange system of claims 1, wherein the elongate member comprises one projecting member that substantially extends along at least a portion of a length of the elongate member.

6. The heat exchange system of claim 5, wherein the at least one projecting member is in the form of a thread that extends along at least a portion of the outer surface of the elongate member to provide the elongate member with an at least partially threaded outer surface.

7. The heat exchange system of claim 5, wherein the outer surface of the elongate member comprises a plurality of projecting members along at least a portion of its length.

8. The heat exchange system of claim 7, wherein the projecting members are shaped as paddles.

9. The heat exchange system of claim 1, wherein the elongate member is located generally centrally within the inner tube so that the longitudinal axes of the inner tube and elongate member generally align.

10. The heat exchange system of claim 1, wherein the inner tube comprises an inner surface and an outer surface and wherein the outer surface comprises at least one projecting member.

11. The heat exchange system of claim 8, wherein the at least one projecting member is in the form of a thread that extends along at least a portion of the outer surface of the inner tube to provide the inner tube with an at least partially threaded outer surface.

12. The heat exchange system of claim 8, wherein the outer surface of the inner tube comprises a plurality of projecting members along at least a portion of its length.

13. The heat exchange system of claim 10, wherein the projecting members are shaped as paddles.

14. A system for converting a raw feedstock sludge comprising organic material into crude oil, the system comprising;
a pressurizing section comprising an inlet and at least one pump to pressurise the feedstock;
a processing section comprising a reactor comprising a heat exchange system according to claim 1, the reactor being configured to heat the feedstock, convert the feedstock to a crude oil within a reaction zone of the reactor, and cool the crude oil before discharging the crude oil from the reactor; and
an output section configured to receive the discharged crude oil from the reactor and comprising a depressurising chamber that depressurises the crude oil before the crude oil is discharged from the system via an outlet.

15. The system of claim 14, wherein the system comprises a fluid flow path between the inlet and the outlet and further comprises a pressure equalisation system to equalise pressures between two valves along the fluid flow path before opening one of the two valves.

16. A heat exchange system for use in the production of crude oil from a raw feedstock sludge comprising organic material, the system comprising:
an outer tube comprising an inner surface and an outer surface and a longitudinal axis running along the length of the outer tube;
a rotatable inner tube concentrically and coaxially located within the outer tube, the inner tube comprising an inner surface and an outer surface;
a stirring arm concentrically and coaxially located within the inner tube;
wherein the inner tube is rotated about the longitudinal axis by a rotational drive system;
wherein the system further includes at least one inlet and at least one outlet;
wherein the stirring arm comprises one or more projecting members extending along a length of the stirring arm; and
wherein the outer surface of the inner tube, or the inner surface of the outer tube, comprises at least one projecting member extending along a length of the respective inner or outer tube.
